(19) United States
(12) Patent Application Publication
(10) Pub. No.: US 2021/0404624 A1
(43) Pub. Date: Dec. 30, 2021

(54) TRANSPARENT PHOTOCONDUCTOR HAVING LIGHT SHIELDING FUNCTION, AND APPLICATION THEREOF

(71) Applicant: HASCO VISION TECHNOLOGY CO., LTD., Shanghai (CN)

(72) Inventor: Jie ZHANG, Shanghai (CN)

(21) Appl. No.: 16/476,315

(22) PCT Filed: May 8, 2017
(86) PCT No.: PCT/CN2017/083411

§ 371 Date: Jul. 8, 2019

(30) Foreign Application Priority Data
Jan. 12, 2017 (CN) 201710022825.7
Feb. 12, 2017 (CN) 201720035887.7

(51) Int. Cl. F21S 41/43; F21S 41/255; F21S 41/365

(52) U.S. Cl. CPC F21S 41/43; F21W 2102/135; F21S 41/365; F21S 41/255

(57) ABSTRACT

A transparent photoconductor (5) is provided with an optical stop structure (5a) and comprises an incident surface (5b), an exit surface (5c) and upper and lower reflection surfaces (5d, 5e); a part of incident light is irradiated to a reflection surface (2a) of a reflection mirror (2) and is directly reflected to a lens (4); another part of the incident light is irradiated to the incident surface (5b) of the transparent photoconductor (5) and refracted to the interior of the transparent photoconductor (5), and passes through the incident surface (5b), and then is refracted to the lens (4) by the exit surface (5c).

### BACKGROUND OF THE INVENTION

### Technical Field

The invention relates to a projection-type illumination system for vehicle lamps, in particular to a transparent photoconductor having a light shielding function, and a projection-type illumination system for vehicle lamps. According to the transparent photoconductor and the projection-type illumination system for vehicle lamps, by replacing a light shielding plate in the prior art with a transparent photoconductor having a light path changing function so as to form a brightness-darkness cutoff line and by reusing stray light formed after light is shielded or reflected by the light shielding plate in three ways for illumination, the total light effect of the projection-type illumination system is improved.

### Description of Related Art

A common projection-type illumination system for automotive lamps generally includes a light source 1, a reflection mirror 2, a light shielding plate 3, and a lens 4, as shown in FIG. 1, wherein the light shielding plate 3 is provided with an optical stop structure 3a; the reflection mirror is ellipsoidal, and the light-emitting center of the light source is located close to the focus of the ellipsoidal reflection mirror; and light emitted by the light source is converged to a position away from the focus of the ellipsoidal reflection mirror after being reflected by the ellipsoidal reflection mirror, the light shielding plate is arranged away from the focus of the ellipsoidal reflection mirror, and finally, a quasi-parallel illumination light shape having a brightness-darkness cutoff line is formed after the light passes through the lens.

As shown in FIG. 2 and FIG. 3, brightness-darkness cutoff lines which are necessary to a passing light shape of a headlamp, and a light shape of a fog lamp are formed through shielding of the optical stop structure 3a which has a shape corresponding to the shapes of brightness-darkness cutoff lines required to meet different illumination requirements. FIG. 10 shows a brightness-darkness cutoff line A of the passing light shape. FIG. 11 shows a brightness-darkness cutoff line B, which is a horizontal line, of the fog lamp.

The optical stop structure 3a which is arranged on the light shielding plate of 3 of the traditional projection-type illumination system to form the brightness-darkness cutoff line has the following defects:

1. One part of light shielded by the optical stop structure 3a cannot be reused, and only a part of light F1 is used for road illumination, so that the wastage of optical energy is caused;

2. One part of the light shielded by the optical stop structure 3a is absorbed by the light shielding plate 3, and one part of the light shielded by the optical stop structure 3a is reflected by the light shielding plate 3; and due to the fact that the reflected light F2 cannot be controlled, stray light may be formed after the reflected light F2 is reflected by other parts in a lamp to be irradiated onto the road surface;

3. One part of the light reflected by the optical stop structure 3a may also be irradiated into other functional regions such as the region of a steering lamp or the region of a position lamp, and consequentially, the light leakage between the functional regions is caused;

and

4. Because an irradiation angle of the light source is generally not smaller than 180°, one part of the light cannot be irradiated onto the reflection mirror, and consequentially, the loss of the optical energy is caused.

### BRIEF SUMMARY OF THE INVENTION

In order to solve the above problems, the invention provides a projection-type illumination system for vehicle lamps, in particular to a transparent photoconductor having a light shielding function, a light path system formed by the transparent photoconductor, a projection-type illumination system for vehicle lamps, and an automotive headlamp. According to the invention, the transparent photoconductor can form a clear brightness-darkness cutoff line, and makes full use of incident light, namely, the utilization rate of the incident light is increased.

The technical solution of the transparent photoconductor having a light shielding function is as follows:

The transparent photoconductor having a light shielding function is arranged between a light source 1 and a lens 4, wherein:

An emergent side, close to the lens 4, of the transparent photoconductor 5 is provided with an optical stop structure 5a used for forming a brightness-darkness cutoff line;

The transparent photoconductor 5 is a rectangular block having a section including stepped upper and lower parts;

The transparent photoconductor 5 is provided with an incident surface 5b, an exit surface 5c, an upper reflection surface 5d, and a lower reflection surface 5e; and

One part of incident light is irradiated to a reflection surface 2a of a reflection mirror 2 and is directly reflected to the lens 4 so as to form a first part G1 of an illumination light shape G.

According to the invention, the transparent photoconductor 5 is the rectangular block having the section including the stepped upper and lower parts, so that the transparent photoconductor can form a clear brightness-darkness cutoff line, and makes full use of the incident light, namely, the utilization rate of the incident light is increased.

According to the transparent photoconductor having a light shielding function:

A light path formed by the transparent photoconductor is as follows:

Another part of the incident light is irradiated to the incident surface 5b of the transparent photoconductor 5 and refracted to the interior of the transparent photoconductor 5, is then refracted to the exit surface 5c or reflected to the exit surface 5c by the upper incident surface 5d, is refracted to the lens 4 by the exit surface 5c, and is projected onto a road surface by means of the lens 4 so as to form a second part G2 (FIG. 7) of the illumination light shape, and the light which is not refracted to the lens 4 by the exit surface (5c) forms a first part H1 of stray light;

Another part of the incident light is irradiated to the reflection surface 2a of the reflection mirror 2, is refracted to the lower reflection surface 5e after being reflected to the upper reflection surface 5d, and is then refracted to the lens 4 by the lower reflection surface 5e so as to form a third part G3 (FIG. 8) of the illumination light shape;

Another part of the incident light is irradiated to the reflection surface (2a) of the reflection mirror (2) and is reflected to the lens (4) after being reflected to the upper reflection surface (5d) so as to form a fourth part G4 (FIG. 9) of the illumination light shape;

Another part of the incident light is irradiated to the reflection surface (2a) of the reflection mirror (2) and is refracted to the interior of the transparent photoconductor (5) after being reflected to the upper reflection surface (5d) so as to change the light path, and after the light path is changed, the light is totally refracted by the exit surface 5c, or is downwards refracted by the lower reflection surface 5e to form a second part H2 of the stray light, so that the brightness-darkness cutoff line is formed; and

The second part H2, formed by downward refraction of the light by the lower reflection surface 5e, of the stray light is not used for road illumination.

According to the transparent photoconductor having a light shielding function,

The upper reflection surface 5d and the lower reflection surface 5e of the transparent photoconductor 5 are planes.

According to the transparent photoconductor having a light shielding function,

The upper reflection surface (5d) of the transparent photoconductor (5) includes stepped upper and lower parts, and the upper part is in oblique transition with the lower part.

According to the transparent photoconductor having a light shielding function,

A height difference between the stepped upper and lower parts of the transparent photoconductor 5 is 1-3 mm.

Preferably, the height difference between the stepped upper and lower parts of the transparent photoconductor 5 is 1.2-1.5 mm.

According to the transparent photoconductor having a light shielding function,

The incident surface 5b and the exit surface 5c of the transparent photoconductor 5 are in a convex arc shape.

According to the transparent photoconductor having a light shielding function,

A portion, corresponding to the upper part over the lower part of the transparent photoconductor 5, of the incident surface is oblique.

According to the transparent photoconductor having a light shielding function,

The brightness-darkness cutoff line is formed due to a light path change caused by light reflection to the interior of the transparent photoconductor (5) by the reflection surface (5d), and one part of the light refracted to the exit surface 5c is totally reflected to be finally irradiated below the transparent photoconductor.

According to the transparent photoconductor having a light shielding function,

The optical stop structure 5a is arranged on the emergent side of the transparent photoconductor.

According to the transparent photoconductor having a light shielding function,

The light source 1 is a semiconductor light-emitting chip.

According to the transparent photoconductor having a light shielding function,

The transparent photoconductor 5 is made from glass through firing and rolling formation or is made from transparent plastic through injection molding.

The invention further provides a projection-type illumination system for vehicle lamps, wherein:

The projection-type illumination system adopts the transparent photoconductor having a light shielding function.

The invention further provides a headlamp, which adopts the projection-type illumination system for vehicle lamps.

The invention has the following beneficial effects: by replacing a light shielding plate in the prior art with a transparent photoconductor having a light path changing function so as to form the brightness-darkness cutoff line and reusing stray light formed after light is shielded or reflected by the light shielding plate in three ways for illumination, the total light effect of the projection-type illumination system is improved. Approach 1: One part of light which is not irradiated to the reflection surface is reflected to the incident surface of the transparent photoconductor 5, and is refracted to the lens 4 by the exit surface 5c after passing through the transparent photoconductor, so as to be used for road illumination. Approach 2: One part of the light is reflected to the upper reflection surface 5d of the transparent photoconductor 5 by the reflection surface 2a of the reflection mirror 2, and is reflected to the lens 4 by the reflection surface 5d, so as to be used for road illumination. Approach 3: One part of the light is reflected to the upper reflection surface 5d of the transparent photoconductor 5 by the reflection surface 2a of the reflection mirror 2, is refracted to the interior of the transparent photoconductor 5 by the reflection surface 5d, and is refracted to the lens 4 by the lower reflection surface 5e, so as to be used for the road illumination. By means of the above three approaches, uncontrolled stray light is reduced while the light effect is improved, that is to say, the utilization rate of the incident light is increased while the clear brightness-darkness cutoff line is formed by the transparent photoconductor.

### BRIEF DESCRIPTION OF THE SEVERAL VIEWS OF THE DRAWINGS

FIG. 1 is a schematic diagram of a common projection-type illumination system for automotive lamps;

FIG. 2 and FIG. 3 are respectively schematic diagrams of brightness-darkness cutoff lines which are necessary to a passing light shape of a headlamp, and a light shape of a fog lamp and are formed through shielding of an optical stop structure 3a;

FIG. 4 is an assembly diagram of the projection-type illumination system for vehicle lamps of the invention;

FIG. 5 is a light refraction and projection diagram of a photoconductor and the illumination system of the invention;

FIG. 6 is a light refraction and projection diagram of the photoconductor and the illumination system of the invention;

FIG. 7 is a light refraction and projection diagram of the photoconductor and the illumination system of the invention;

FIG. 8 is a light refraction and projection diagram of the photoconductor and the illumination system of the invention;

FIG. 9 is a light refraction and projection diagram of the photoconductor and the illumination system of the invention;

FIG. 10 is a schematic diagram of brightness-darkness cutoff line A of the passing light shape;

FIG. 11 is a schematic diagram of the brightness-darkness cutoff line, namely a horizontal line, of the fog lamp.

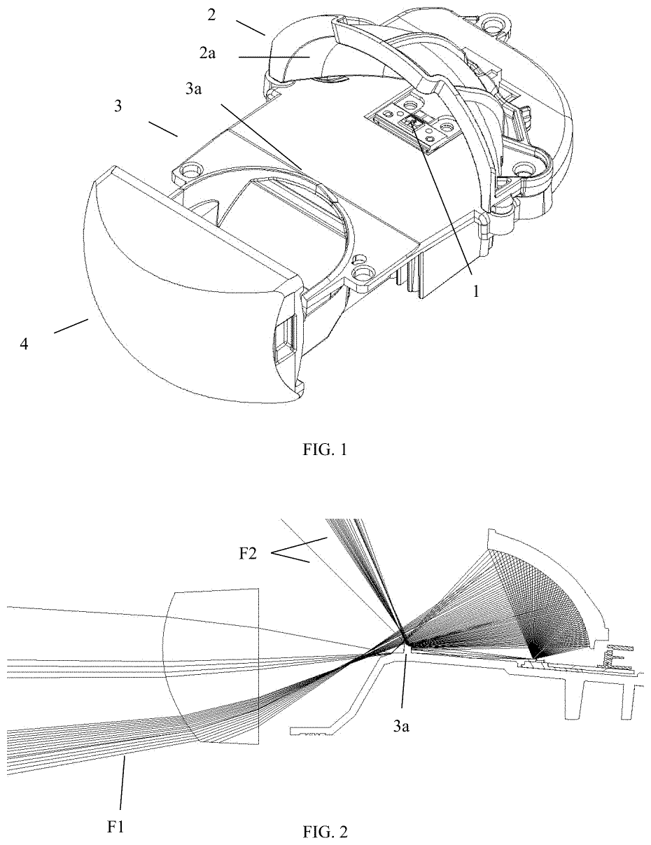

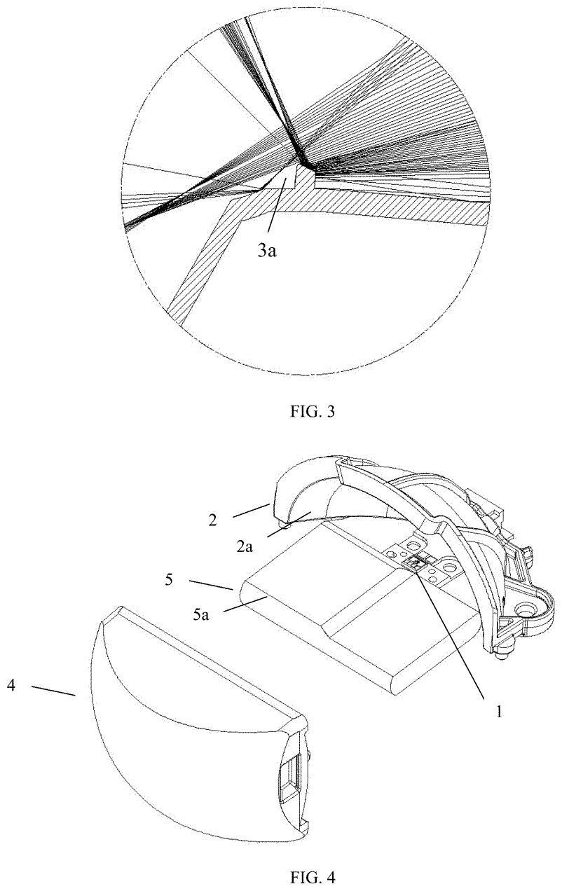

Reference Signs: 1, light source; 2, reflection mirror; 2a, reflection surface of reflection mirror 2; 3, light shielding plate; 3a, optical stop structure; 4, lens; 5, transparent photoconductor; 5a, optical stop structure; 5b, incident surface; 5c, exit surface; 5d, upper reflection surface; 5e, lower reflection surface. A is the brightness-darkness cutoff line of the passing light shape, and B is the brightness-darkness cutoff line of the fog lamp; F1 is illumination light of an existing projection-type illumination system, and F2 is stray light; G is illumination light of the illumination system of the invention and includes G1, G2, G3, and G4 according to their origins wherein G1 is a first part, formed after a part of incident light is directly reflected to the lens 4 by the reflection surface 2a, of an illumination light shape G, G2 is a second part, formed after another part of the incident light is refracted to the interior of the photoconductor 5 by the incident surface 5b, is then refracted to the exit surface 5c or reflected to the exit surface 5c by the upper reflection surface 5d and is then refracted to the lens 4, of the illumination light shape, G3 is a third part, formed after another part of the incident light passes through the reflection surface 2a, is refracted to the lower reflection surface 5e by the upper reflection surface 5d, and is then refracted to the lens, of the illumination light shape, and G4 is a fourth part, formed after the incident light passes through the reflection surface (2a) and is then reflected to the lens (4) by the upper reflection surface (5d), of the illumination light shape; and H is the stray light of the illumination system of the invention and includes a first part H1 and a second part H2 according to their origins.

### DETAILED DESCRIPTION OF THE INVENTION

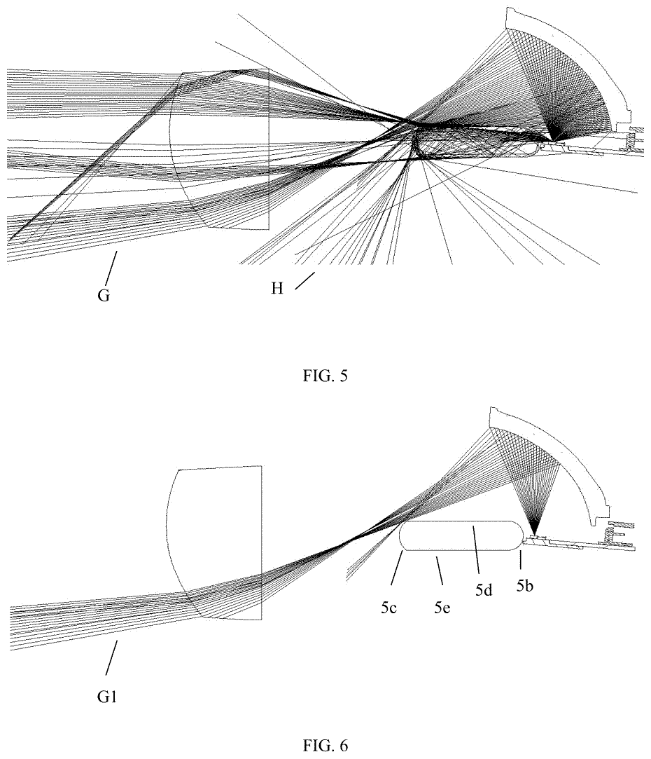

As shown in FIG. 4 and FIG. 5, an illumination system of the invention includes a light source 1, a reflection mirror 2, a transparent photoconductor 5 and a lens 4, wherein the transparent photoconductor 5 is provided with an optical stop structure 5a used for forming a brightness-darkness cutoff line and is further provided with an incident surface 5b, an exit surface 5c, an upper reflection surface 5d, and a lower reflection surface 5e; and the light source 1 is preferably a semiconductor light-emitting chip. One part of light emitted by the light source 1 is irradiated to a reflection surface 2a of the reflection mirror 2 and is partially reflected by the reflection surface 2 to the lens 4, and the other part of the light is reflected to the upper reflection surface 5d, as shown in FIG. 5; and one part of the light is irradiated to the incident surface 5b of the transparent photoconductor 5 and is refracted to the interior of the transparent photoconductor 5.

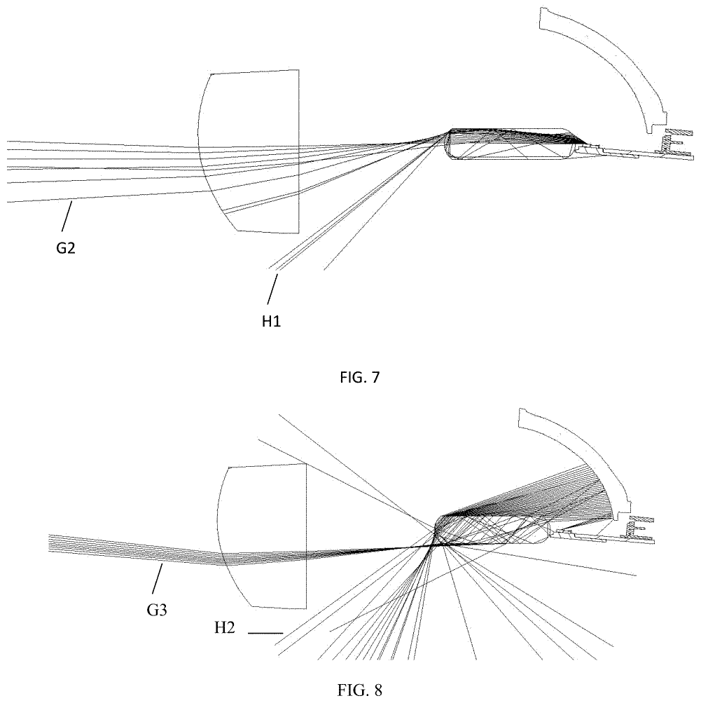

One part of the light refracted to the interior of the photoconductor 5 is refracted to the exit surface 5c by the incident surface 5b or reflected to the exit surface 5c by the upper reflection surface 5d, is then refracted to the lens 4 by the exit surface 5c, and is projected onto a road surface by means of the lens 4 so as to form one part G2 (FIG. 7) of the illumination light shape.

Another part of the incident light is irradiated to the reflection surface 2a of the reflection mirror 2, is refracted to the lower reflection surface 5e after being reflected to the upper reflection surface 5d, and is then refracted to the lens 4 by the lower reflection surface 5e so as to form another part G3 (FIG. 8) of the illumination light shape; and as shown in FIG. 8, the incident light is projected to the road surface by the lens 4 so as to form one part of the illumination light shape.

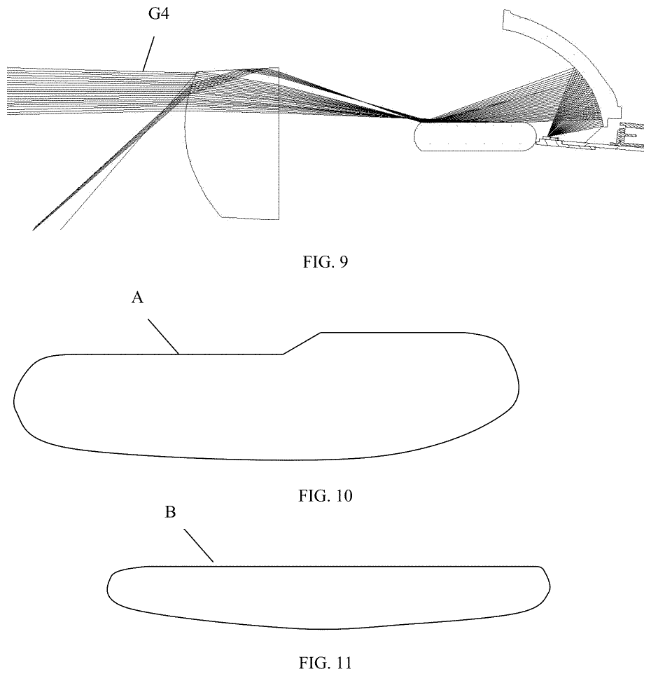

Another part of the incident light is irradiated to the reflection surface (2a) of the reflection mirror (2) and is reflected to the lens (4) after being reflected to the upper reflection surface (5d) so as to form another part G4 (FIG. 9) of the illumination light shape.

A light path change caused by light reflection to the interior of the transparent photoconductor 5 by the reflection surface 5d is the key to forming the brightness-darkness cutoff line, wherein one part of the light refracted to the exit surface 5c is totally reflected due to the fact that an incident angle is larger than a total reflection angle; as shown in FIG. 8, the light is finally irradiated below the transparent photoconductor to form uncontrollable stray light H2 and cannot reach the lens 4 to be used for road illumination, thereby being incontrollable light.

One part of the light refracted to the lower reflection surface 5e is refracted to the lens 4 by the lower reflection surface 5e so as to form one part of the illumination light shape, and a light path change caused by two times of light refraction by the upper reflection surface 5d and the lower reflection surface 5e is also a key to forming the brightness-darkness cutoff line.

According to the transparent photoconductor and the projection-type illumination system for vehicle lamps, by replacing a light shielding plate in the prior art with the transparent photoconductor having a light shielding function so as to form the brightness-darkness cutoff line and reusing stray light after light is shielded or reflected by the light shielding plate in three ways for illumination the total light effect of the projection-type illumination system is improved.

1. A transparent photoconductor having a light shielding function, being arranged between a light source (1) and a lens (4), wherein:
an emergent side, close to the lens (4), of the transparent photoconductor (5) is provided with an optical stop structure (5a) used for forming a brightness-darkness cutoff line;
the transparent photoconductor (5) is a rectangular block having a section including stepped upper and lower parts;
the transparent photoconductor (5) is provided with an incident surface (5b), an exit surface (5c), an upper reflection surface (5d), and a lower reflection surface (5e); and
one part of incident light is irradiated to a reflection surface (2a) of a reflection mirror (2) and is directly reflected to the lens (4) so as to form a first part (G1) of an illumination light shape.

2. The transparent photoconductor having a light shielding function according to claim 1, wherein:
a light path formed by the transparent photoconductor is as follows:
another part of the incident light is irradiated to the incident surface (5b) of the transparent photoconductor (5) and refracted to an interior of the transparent photoconductor (5), is then refracted to the exit surface (5c) or reflected to the exit surface (5c) by the upper incident surface (5d), is refracted to the lens (4) by the exit surface (5c), and is projected onto a road surface by means of the lens (4) so as to form a second part (G2) of the illumination light shape, and the light which is not refracted to the lens (4) by the exit surface (5c) forms a first part (H1) of stray light;
another part of the incident light is irradiated to the reflection surface (2a) of the reflection mirror (2), is refracted to the lower reflection surface (5e) after being reflected to the upper reflection surface (5d), and is then refracted to the lens (4) by the lower reflection surface (5e) so as to form a third part (G3) of the illumination light shape;
another part of the incident light is irradiated to the reflection surface (2a) of the reflection mirror (2) and is reflected to the lens (4) after being reflected to the upper reflection surface (5d) so as to form a fourth part (G4) of the illumination light shape; and
another part of the incident light is irradiated to the reflection surface (2a) of the reflection mirror (2) and is refracted to the interior of the transparent photoconductor (5) after being reflected to the upper reflection surface (5d) so as to change the light path, and after the light path is changed, the light is totally refracted by the exit surface (5c), or is downwards refracted by the lower reflection surface (5e) to form a second part (H2) of the stray light, so that the brightness-darkness cutoff line is formed.

3. The transparent photoconductor having a light shielding function according to claim 1, wherein:
the upper reflection surface (5d) and the lower reflection surface (5e) of the transparent photoconductor (5) are planes.

4. The transparent photoconductor having a light shielding function according to claim 3, wherein:
the upper reflection surface (5d) of the transparent photoconductor (5) includes stepped upper and lower parts, and the upper part is in oblique transition with the lower part.

5. The transparent photoconductor having a light shielding function according to claim 4, wherein:
a height difference between the stepped upper and lower parts of the transparent photoconductor (5) is 1-3 mm.

6. The transparent photoconductor having a light shielding function according to claim 1, wherein:
the incident surface (5b) and the exit surface (5c) of the transparent photoconductor (5) are in a convex arc shape.

7. The transparent photoconductor having a light shielding function according to claim 1, wherein:
a portion, corresponding to the upper part over the lower part of the transparent photoconductor (5), of the incident surface is oblique.

8. The transparent photoconductor having a light shielding function according to claim 1, wherein:
the brightness-darkness cutoff line is formed due to a light path change caused by light reflection to the interior of the transparent photoconductor (5) by the reflection surface (5d), and one part of the light refracted to the exit surface (5c) is totally reflected to be finally irradiated below the transparent photoconductor.

9. A projection-type illumination system for vehicle lamps, comprising a light source (1), a reflection mirror (2) arranged beside the light source (1), as well as a lens (4) arranged on an emergent side, wherein the projection-type illumination system adopts the transparent photoconductor having a light shielding function according to claim 1.

10. A headlamp, adopting the projection-type illumination system for vehicle lamps according to claim 8.
